(19) United States
(12) Patent Application Publication
(10) Pub. No.: US 2007/0214905 A1
(43) Pub. Date: Sep. 20, 2007

(54) Method for cooling a friction shift element of a transmission

(75) Inventors: Armin Gierling, Langenargen (DE); Christian Popp, Kressbronn (DE); Klaus Steinhauser, Kressbronn (DE); Peter Schiele, Kressbronn (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 11/717,446

(22) Filed: Mar. 13, 2007

(30) Foreign Application Priority Data
Mar. 15, 2006 (DE) 10 2006 011 801.4

(51) Int. Cl. F16H 57/04; F16D 13/72

(52) U.S. Cl. 74/336 R; 192/113.35

(57) ABSTRACT

A method for cooling a friction shift element of a transmission is proposed, wherein a variable, a constant or the maximum amount of cooling oil is fed to the friction shift element in a time-controlled manner, specifically within an aftercooling phase.

This application claims priority from German Application Serial No. 10 2006 011 801.4 filed Mar. 15, 2006.

### FIELD OF THE INVENTION

The present invention relates to a method for cooling a friction shift element of a transmission.

### BACKGROUND OF THE INVENTION

In automatic transmissions that comprise a converter and a diesel-starting support (DAFU) or a launch-control function, the clutch or the friction shift elements are placed under heavy stress. This is also the case with double clutch transmissions, automated manual transmissions and automatic transmissions in which the starting procedure is facilitated by means of a starting clutch, generally configured as a friction shift element.

The prior art teaches that wet friction clutches can be supplied with cooling oil. The cooling oil supply can be kept constant via a hydraulic valve. The cooling oil supply can also be varied by means of an appropriate hydraulic control unit.

DE 10 2004 041 160 A1 discloses a method for cooling a friction device or friction element, where the current temperature of the friction element can be calculated based on a temperature model for the friction element. To protect the friction element from damage or excessive stress, the amount of cooling oil is regulated based on the calculated temperature of the friction element.

The disadvantage of this known method is that it is very expensive and complicated, because the appropriate physical data (e.g., heat input, heat dissipation, heat absorption behavior as a function of the cooling oil stream) necessary for the temperature model employed must be obtained through exhaustive measurements. In addition to this, the analysis of this data requires a high amount of computing resources.

The object of the present invention is to provide a method for cooling a friction shift element of a transmission that avoids the described disadvantages of the method known from the prior art and facilitates effective cooling of the friction shift element. In particular, the computing resources required for executing this method and the measurement complexity should both be reduced.

### SUMMARY OF THE INVENTION

According to the invention, a method for cooling a frictional shifting element of a transmission is proposed, wherein a variable, a constant or the maximum amount of cooling oil is fed to the frictional shifting element in a time-controlled manner (specifically, within an aftercooling phase).

According to an advantageous embodiment of the inventive method, the duration of the cooling and/or aftercooling phases is determined as a function of at least one of the available/possible variable amount of cooling oil,

the difference in rotational speed when the clutch is engaged (that is, the difference in rotational speed of the friction shift element at the start of shifting);

the duration of the shifting (that is, the time from the rotational speed when the clutch is engaged to the target rotational speed);

the sump temperature or the temperature of a further temperature measurement site that is ascertained by a temperature sensor,

the clutch torque;

the absolute clutch input and/or output rotational speeds;

the current clutch stress;

the current transmission input or output rotational speed or difference in rotational speeds;

the rotational speed of the lubrication-cooling oil pump;

of the number of previous starts or occurrences of increased clutch stress in the aftercooling phase (aftercooling time) or within a prescribed time interval, and

as a function of the gear or shifting.

Clutch torque can be the average clutch torque or the highest clutch torque reached during shifting.

According to the invention, the appropriate characteristic curves, performance characteristics, fixed values, offsets and/or other factors are linked to one another by means of a computational algorithm to execute the method.

The invention also provides that after the time frame for cooling (when aftercooling phase has elapsed) has been reached, the cooling oil stream can be switched back to a minimum.

In an advantageous manner an appropriate limitation of torque can be performed when the friction clutch is subjected to new stress (e.g. new starts) within the time-controlled aftercooling phase to keep the friction clutch from becoming damaged. A torque limitation can be executed in a graduated manner on the basis of starts or stresses appearing consecutively.

If, for example, a new start takes place or stress is placed on the friction clutch within the time-controlled aftercooling phase, a counter is counted up, wherein the counter value is used as a value for calculating the subsequent time duration of the aftercooling phase and/or serves for graduated torque reduction. According to the invention, the amount of the counter value can be selected based on the residual time of the aftercooling phase.

Through the inventive idea, a method for cooling a friction shift element is provided that facilitates effective cooling while reducing computing resources, complexity of measurements and system complexity.

1-9. (canceled)

10. A method for cooling a friction shift element of a transmission, wherein one of a variable, a constant and a maximum volume of cooling oil is fed to the friction shift element within an aftercooling phase.

11. The method for cooling the friction shift element of the transmission according to claim 10, wherein a duration of a cooling and the aftercooling phases is determined as a function of at least one of:
one of the variable, the constant and the maximum volume of the cooling oil;
a difference in a rotational speed when the shift element is engaged;
a duration of shifting;
a sump temperature or a temperature of a further temperature measurement site as ascertained by one or more of a temperature sensor;
a clutch torque;
one of an absolute clutch input and an output rotational speeds;
a current clutch stress;
one of a current transmission rotational input speed, a current transmission output rotational speed and a difference in the current input and the output rotational speeds;
a lubrication-cooling oil pump rotational speed;
one of a number of previous starts, a number of occurrences of increased clutch stress in the aftercooling phase and within a prescribed time interval; and
one of a function of gear and shifting.

12. The method for cooling the friction shift element of the transmission as claimed in claim 11, wherein one of a coupling torque, an average coupling torque and a highest coupling torque present during shifting is used.

13. The method for cooling the friction shift element of the transmission according to claim 10, wherein one or more of appropriate characteristic curves, performance characteristics, fixed values, offsets and other factors are linked by means of a computational algorithm to execute the method.

14. The method for cooling the friction shift element of the transmission according to claim 10, wherein after one of a time frame for cooling has been reached and the aftercooling phase has elapsed, the volume of cooling oil is switched back to a minimum.

15. The method for cooling the friction shift element of the transmission according to claim 10, wherein an appropriate limitation of torque is performed when the friction shift element is subjected to new stress within the time-controlled aftercooling phase to keep the friction shift element from becoming damaged.

16. The method for cooling the friction shift element of the transmission according to claim 15, wherein torque limitation is executed in a graduated manner on a basis of one or more of starts and stresses occurring consecutively.

17. The method for cooling the friction shift element of the transmission according to claim 16, wherein if one of a new start takes place and a stress is placed on the friction shift element within a time-controlled aftercooling phase, a counter is counted up, a counter value being used as a value for one of calculating a subsequent time duration of the aftercooling phase and serving a graduated torque reduction.

18. The method for cooling the friction shift element of the transmission according to claim 17, wherein the value of the counter value is selected based on a residual time of the aftercooling phase.

19. A method for cooling a friction shift element of a transmission, the method comprising the steps of:
determining a cooling phase duration of time during which a volume of oil is supplied to the friction shift element;
supplying the volume of oil to the friction shift element to withdraw heat during the duration of time of the cooling phase;
determining an aftercooling phase duration of time during which the volume of the oil supplied to the friction shift element, over the duration of time of the cooling phase, is cooled; and
allowing the volume of oil from the friction shift element to release heat over the duration of time of the aftercooling phase;
the lengths of time of the cooling phase and the aftercooling phase are determined as a function of one or more of:
a difference in a rotational speeds within the friction shift element at a start of shifting;
a duration of time for the rotational speeds within the friction shift element at a start of the shifting to reach a target rotational speed;
one of a temperature of a sump and a temperature of an additional temperature measurement site, as determined with a temperature sensor;
a torque of the friction shift element;
at least one of a clutch input rotational speeds and a clutch output rotational speed;
a current clutch stress;
at least one of a current transmission input rotational speed, a output rotational speed, and a difference in the current transmission input and output rotational speeds;
a lubrication-cooling oil pump rotational speed;
a numerical quantity of previous starts and occurrences of increased clutch stress during at least one of the duration of time of the aftercooling phase and within a prescribed time interval; and
a function of one of a gear and shifting.

20. The method for cooling the friction shift element of the transmission according to claim 19, further comprising the step of using one of an average coupling torque and a highest coupling torque present during shifting for determining the lengths of time of the cooling phase and the aftercooling phase.

21. The method for cooling the friction shift element of the transmission according to claim 19, further comprising the step of using one or more of appropriate characteristic curves, performance characteristics, fixed values, offsets and additional factors linked by means of a computational algorithm.

22. The method for cooling the friction shift element of the transmission according to claim 19, further comprising the step of returning a flow of the volume of oil to a minimum after at least one of the lengths of time of the cooling phase and the aftercooling phase have elapsed.

23. The method for cooling the friction shift element of the transmission according to claim 19, further comprising the step of limiting torque when the friction shift element is subjected to a new stress within the duration of time of the cooling phase to prevent the friction shift element from becoming damaged.

24. The method for cooling the friction shift element of the transmission according to claim 23, further comprising the step of executing the step of limiting torque a graduated manner on a basis of one of consecutive starts and consecutive stresses.

25. The method for cooling the friction shift element of the transmission according to claim 24, further comprising the step of numerically increasing a counter value when the friction shift element is subjected to a new stress within the duration of time of the aftercooling phase and using the counter value to calculate one or more of a subsequent duration of time of the aftercooling phase and the graduated manner of limiting the torque.

26. The method for cooling the friction shift element of the transmission according to claim 25, further comprising the step of selecting the amount of the counter value can be selected based on the residual time of the aftercooling phase.
